(19) United States
(12) Patent Application Publication
(10) Pub. No.: US 2025/0235724 A1
(43) Pub. Date: Jul. 24, 2025

(54) Mask

(71) Applicant: Chit Kwan Yau, Ma On Shan (HK)

(72) Inventor: Chit Kwan Yau, Ma On Shan (HK)

(21) Appl. No.: 18/700,040

(22) PCT Filed: May 16, 2023
(86) PCT No.: PCT/CN2023/094588

§ 371 Date: Apr. 10, 2024

(30) Foreign Application Priority Data
May 18, 2022 (CN) 20221190429.8

(51) Int. Cl. A62B 23/02; A62B 18/10

(52) U.S. Cl. CPC A62B 23/02; A62B 18/10

(57) ABSTRACT

A mask includes a first frame body, a light-transmitting piece, and a filtering assembly. The first frame body is used for covering the face of a user and is provided with a first through hole opposite the lips of the user. The light-transmitting piece covers the edges of the first through hole to seal and block it. Light rays on the inner side of the first frame body transmit to the outer side thereof through the light-transmitting piece, which has a convex shape. The filtering assembly is used for filtering the air inhaled and exhaled. As the light-transmitting piece is convex, the light transmitted therethrough can be dispersed in a fan shape, and other people can observe the lip movement without being directly in front of the user, thereby improving the communication efficiency between the user and other people.

This application claims priority from the Chinese Patent Application No. 202221190429.8, entitled “Mask,” filed May 18, 2022, at the Chinese Patent Office, the entire contents of which are incorporated herein by reference.

### TECHNICAL FIELD

The present application relates to the technical field of air filtration, and in particular to a mask.

### BACKGROUND

The statements herein merely provide background information related to the present disclosure, and do not necessarily constitute prior art. Melt-blown cloth is generally used as the filter element, and in order to ensure the filtering effect, the melt-blown cloth cover part of a face for filtering the air inhaled and exhaled by the mask user.

However, the mask is designed in such a way that other people will not be able to know the mouth shape of the mask's user. In some special scenarios, the mouth shape can be used as an important means of communication, such as the scenario in which the hearing impaired need to communicate with each other by reading lips through the mouth shape and the scenario in which it is difficult to communicate in a noisy environment and with difficult-to-distinguish voices.

In this regard, the patent No. CN215837224U discloses a mask, wherein the user is able to conveniently communicate with other people in the scenario by seeing lips through a light-transmitting member and an opening on the body of the mask opposite to the user's lips, thereby improving the efficiency of communication between the user and other people. However, the light transmissive sheet of this mask is in the shape of a flat plate, so that the lip movements of the user can only be observed when other people are directly in front of the user, and the visual range is small.

### Technical Problem

It is one of the objects of embodiments of the present application to provide a mask intended to solve the problem that when the mask uses a flat plate-like light-transmitting member, the lip movements of the user can only be observed when another person is directly in front of the user.

### Technical Solution

In order to solve the above technical problem, the technical solution adopted in the embodiments of the present application is:

In a first aspect, there is provided a mask comprising: a first frame, a light transmissive sheet, and a filtration assembly; wherein the first frame is used to cover a face of a user; wherein the first frame comprises a first opening directing to lips of the user; wherein the light transmissive sheet engages an edge of first opening to cover the first opening, and the light on an inner side of the first frame is able to be projected to an outer side of the first frame through the light transmissive sheet; wherein the light transmissive sheet has a convex shape; wherein the filter assembly is adapted to filter inhaled and exhaled air; wherein the filter assembly comprises a base and a filter element; wherein the base is configured in an inner side of light transmissive sheet and comprises an air exchange channel inside; wherein the light transmissive sheet comprises air holes connected to the air exchange channel, and the filter element is installed inside the air exchange channel.

In one embodiment, the mask further comprises a soft cushion; the soft cushion is disposed on the inside of the first frame and is adapted to contact with a user's face; the soft cushion is disposed around the edge of the first opening.

In one embodiment, the mask further comprises a second frame; wherein the second frame is enclosed to form a second opening; the second frame is stacked on an outer side of the first frame, an outer edge of the first frame and an outer edge of the second frame are detachably connected by a buckle, the first opening is connected with the second opening, and the light-transmitting sheet is clamped between the first frame and the second frame.

In one embodiment, the first frame has a buckle seat at a left side edge and a right side edge thereof respectively. The positions of the second frame that is close to the left side edge and that is close to the right side edge have a buckle respectively, wherein the buckles are located on an inner side of the second frame, and the buckle and the buckle seat are adapted to be connected to each other.

In one embodiment, the mask further comprises a suspension assembly for hanging on a user's ears, head or neck; the suspension assembly is connected to the second frame.

In one embodiment, the second frame has an opening at a position close to the left side edge and a position close to the right side edge respectively; the suspension assembly comprises a belt, and the belt passes through the opening for connecting to the second frame; or the suspension assembly comprises a rope, and the rope passes through the opening for connecting to the second frame.

In one embodiment, the light-transmitting sheet comprises an anti-haze cover layer on a surface thereof.

In an embodiment, the mask comprises a plurality of filter assemblies, and the bases of the plurality of the filter assemblies are located in a compartment on an insider side of the light transmissive sheet.

In one embodiment, the filter element comprises a filter sponge or a filter sheet having an accordion-type structure.

In one embodiment, the base has a rectangular frame shape.

### Beneficial Effects

In one embodiment of the present application, there is provided a mask that has the beneficial effects as follows: the light-transmitting sheet of the present embodiment being convex in shape, so that the light transmitted through the light-transmitting sheet can be scattered in a fan shape, and other people can see the lip movements of the user without standing in front of the user, thereby improving the communication efficiency between the user and other people. In addition, by arranging the light-transmitting sheet as the outer convex sheet-shaped structure, the overall thickness and weight of the light-transmitting sheet can also be reduced, thereby facilitating sound transmission.

### BRIEF DESCRIPTION OF THE DRAWINGS

In order to more clearly illustrate the technical solutions in the embodiments of this application, the accompanying drawings of the embodiments are provided or the exemplary technical descriptions are briefly described below. Obviously, the accompanying drawings in the following description merely represent some embodiments of this application. A person of ordinary skilled in the art may derive other accompanying drawings according to these accompanying drawings without creative efforts.

FIG. 1 is a diagram of a mask according to an embodiment of this application;

FIG. 2 is another diagram of a mask according to an embodiment of this application;

FIG. 3 is an exploded view diagram of a mask according to an embodiment of this application;

FIG. 4 is a cross-sectional view diagram of a mask according to an embodiment of this application;

FIG. 5 is a vertical sectional view diagram of a mask according to an embodiment of this application;

FIG. 6 is a structural diagram of a light transmissive sheet and a filter assembly of a mask according to an embodiment of this application;

FIG. 7 is another structural diagram of a light transmissive sheet and a filter assembly of a mask according to an embodiment of this application;

FIG. 8 is a vertical sectional view diagram of the filter assembly shown in FIGS. 6 and 7;

FIG. 9 is a structural diagram of a light transmissive sheet of a mask and another filter assembly according to an embodiment of this application;

FIG. 10 is another structural diagram of a light transmissive sheet and another filter assembly of a mask according to an embodiment of this application;

FIG. 11 is a vertical sectional view of the filter assembly shown in FIGS. 9 and 10;

FIG. 12 is a structural diagram of a second frame of a mask and a suspension assembly according to an embodiment of this application;

FIG. 13 is a structural diagram of a second frame and another suspension assembly of a mask according to an embodiment of this application;

FIG. 14 is a structural diagram of a second frame of a mask and another suspension assembly according to an embodiment of this application;

FIG. 15 is a structural diagram of a mask including a one-way valve according to an embodiment of this application;

FIG. 16 is a schematic structural diagram of the light-transmitting sheet in FIG. 15;

FIG. 17 is a schematic structural diagram of the one-way valve in FIG. 15;

FIG. 18 is a schematic cross-sectional view diagram of the one-way valve in FIG. 15;

FIG. 19 is an exploded view diagram of the one-way valve in FIG. 17;

FIG. 20 is a schematic structural diagram of the base in FIG. 17;

FIG. 21 is a schematic structural diagram of the outer cover in FIG. 17.

In the drawings, 100, the first frame; 110, the first opening; 120, the buckle seat; 200, the light-transmitting sheet; 210, the air holes; 220, the air outlet;
300 filter assembly; 310, base; 311, plate; 312, cover; 320, filter element;
400 a soft cushion;
500 second frame; 510, second opening; 520, buckle; 530, through hole;
600 suspension assembly; 610, belt; 620, rope; 630, adjusting buckle;
700 one-way valve; 710, base; 711, bottom plate; 712, first convex ring; 713, mounting plate; 7131, first opening; 7132, connecting strip; 714, mounting column; 715, first convex rib; 720, outer cover; 721, cover plate; 7211, second through groove; 722, second convex ring; 723, second convex rib; 730, diaphragm; 740, valve cavity.

### EMBODIMENTS OF THE INVENTION

In order to clarify the objectives, technical solutions, and advantages of this application, there is provided the following descriptions of this invention in details with reference to the accompanying drawings and embodiments. It should be understood that the specific embodiments described herein are only used to explain the present disclosure and are not intended to limit the present disclosure.

It should be noted that when a component is referred to as being “affixed to” or “disposed on” another component, it may be directly on or indirectly on another component. When a component is referred to as being “connected to” another component, it may be directly or indirectly connected to the other component. The orientation or positional relationship indicated by the terms “upper”, “lower”, “left”, “right” and the like is only for ease of description, rather than indicating or implying that the referred device or element must have a specific orientation, and is constructed and operated in a specific orientation, and therefore the orientation or positional relationship cannot be understood as a limitation to the present application, and a person of ordinary skill in the art may understand the specific meanings of the above terms according to specific situations. The terms “first” and “second” are only used for convenience of description and cannot be understood as indicating or implying relative importance or implicitly indicating the number of technical features. The meaning of “a plurality of” is two or more unless specifically defined otherwise.

To illustrate the technical solutions of the present application, the following provides detailed descriptions with references to specific accompanying drawings and embodiments.

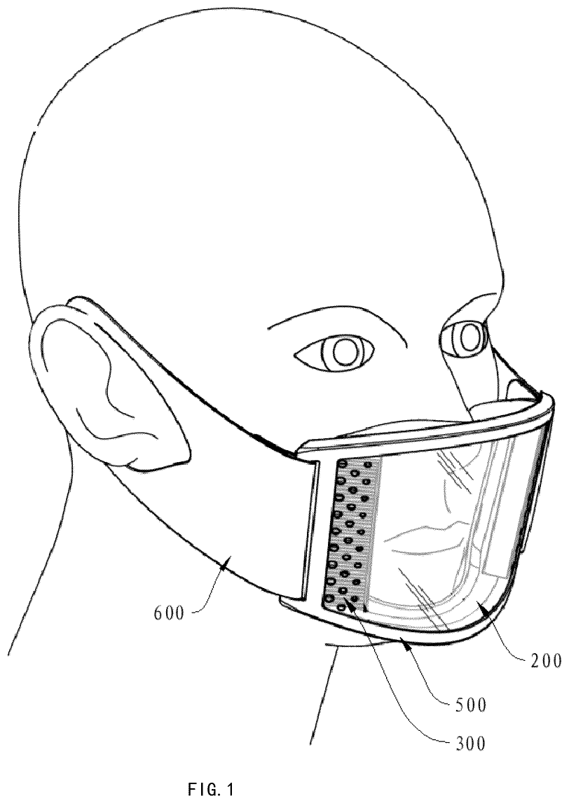

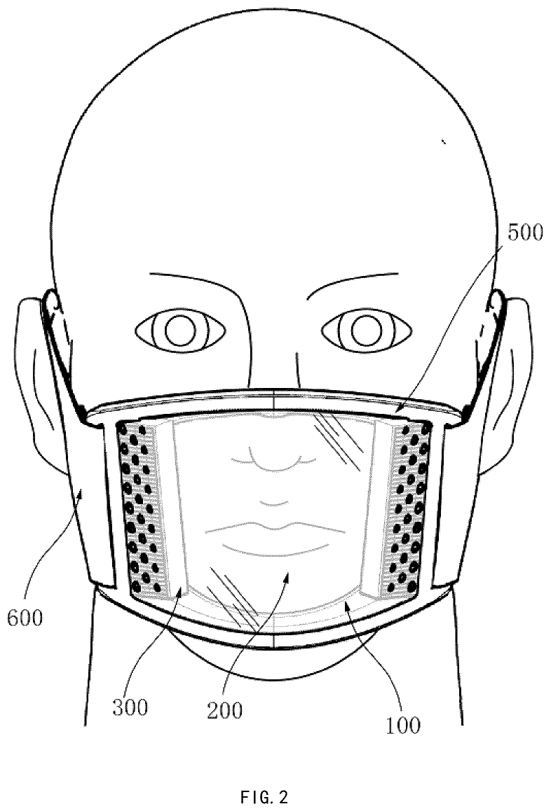

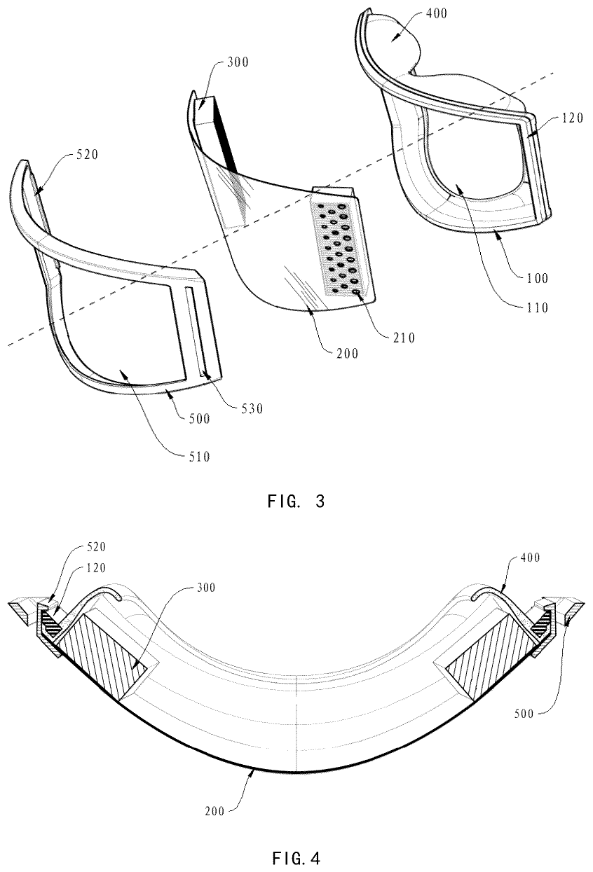

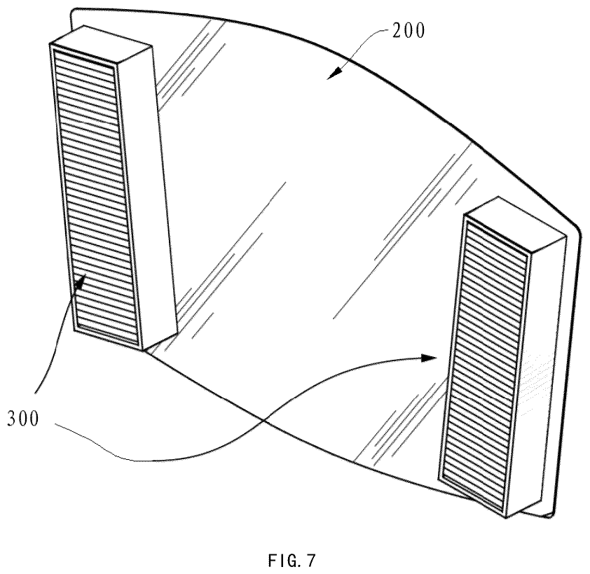

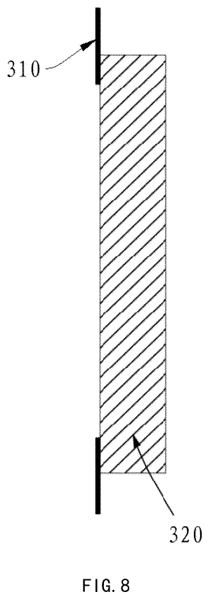

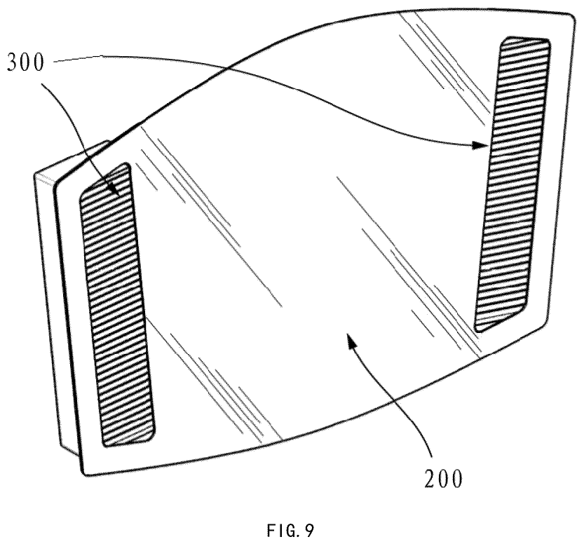

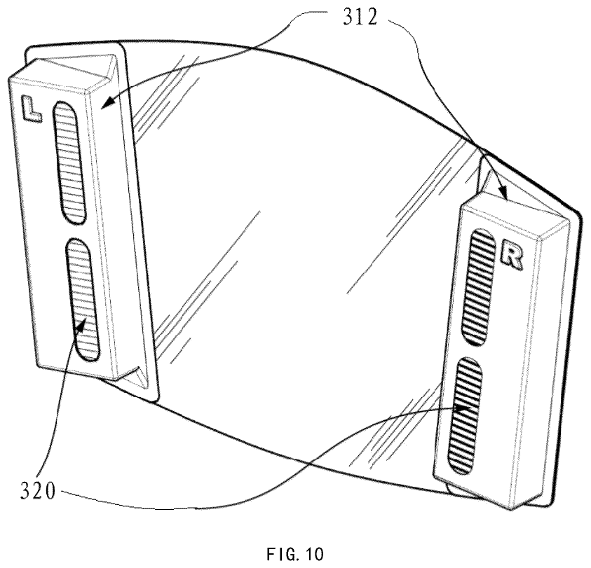

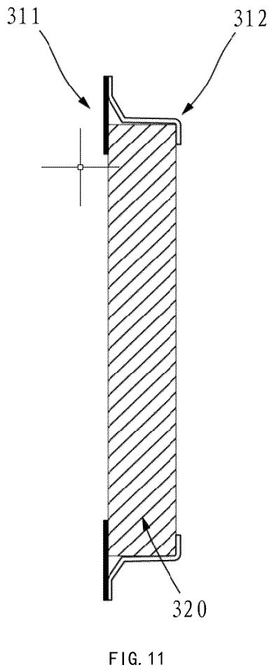

Referring to FIG. 1 to FIG. 13, there is provides a mask according to a preferred embodiment of this application comprising a first frame 100, a light-transmitting sheet 200, and a filter assembly 300. The first frame 100 is used for covering a face of the user. The first frame 100 comprises a first opening 110 opposite to the lips of a user. The light transmitting sheet 200 engages the edge of the first opening 110 to cover the first opening 110, such that light on an inner side of the first frame 100 can be transmitted to an outer side of the first frame 100 through the light transmitting sheet 200. The light transmitting sheet 200 has a convex shape. The filtering assembly 300 is adapted to filtering air inhaled and exhaled. The filtering assembly 300 comprises a base 310 and a filter element 320. The base 310 is arranged on the inner side of the light transmitting sheet 200 and comprises a ventilation channel internally. The light-transmitting sheet 200 has air holes 210 in communication with the ventilation channel. The filter element 320 is installed inside the ventilation channel.

When the mask provided in this embodiment is in use, the first frame 100 is covered on the face of the user, so that the first frame 100 along with the light-transmitting sheet 200 and the face of the user form an enclosed space such that the lips and nose of the user are within the enclosed space. During inhalation, air enters the ventilation channel through the air holes 210 on the light-transmitting sheets 200, and enters the enclosed space after being filtered by the filter element 320 inside the ventilation channel for the user to inhale. The gas exhaled by the user enters the enclosed space and passes through the ventilation channel, and after being filtered by the filter element 320 inside the ventilation channel, the gas exits out from the air hole 210 on the light-transmitting sheet 200, so that the user completes one complete breathing cycle.

When in use, since the first opening 110 is opposite to the lips of the user, the light can be transmitted out of the first opening 110 and through the light-transmitting sheet 200, such that other people can see the lips movement of the user.

Compared with the related prior art, the light-transmitting sheet 200 of the present embodiment is convex in shape, so that the light transmitted through the light-transmitting sheet 200 can be scattered in a fan shape, and other people can observe the lip movement of the user without standing in front of the user, thereby improving the communication efficiency between the user and other people. In addition, by designing the light-transmitting sheet 200 as a convex shaped structure, the overall thickness and weight of the light-transmitting sheet 200 can also be reduced, thereby facilitating sound transmission.

Optionally, the light-transmitting sheet 200 can be rectangular. Optionally, the light-transmitting sheet 200 may also have other shapes such as a circle, a three-dimensional shape, and the like.

Optionally, the light-transmitting sheet 200 can be made as follows: when the user wears the mask of the embodiment on the face of the user, the light-transmitting sheet 200 is inclined downwards. Firstly, in this configuration, the top end position of the mask can be lowered and will not affect the position when the user wearing glasses. Secondly, this configuration can reduce the reflection of light that obstructs others from seeing the face of the user. Thirdly, the visual angle below the eyes of the user will be increased.

Optionally, decorations may be added to the mask as three-dimensional components or printed on the planar surface of the light-transmitting sheet 200.

In some embodiments, referring to FIG. 1 to FIG. 13, the mask further comprises a soft cushion 400. The soft cushion 400 is disposed on an inner side of the first frame 100 and is configured to be in contact with a user's face. The soft cushion 400 is disposed around an edge of the first opening 110. In this embodiment, with the configuration of the soft cushion 400, the mask will not exert excessive pressure on the face of the user to improve the comfort of the mask. Preferably, the shape of the soft cushion 400 is complementary to the face of the user, for example, the soft cushion 400 is provided with a groove that is complementary to the nose bridge, so as to further improve the wearing comfort for the user.

In some embodiments, referring to FIG. 1 to FIG. 13, the mast further comprises a second frame 500. The second frame 500 comprises a second opening 510. The second frame 500 is adapted to be stacked on an outer side of the first frame 100. An outer edge of the first frame 100 and an outer edge of the second frame 500 are detachably connected by a buckle. The first opening 110 is in communication with the second opening 510. The light-transmitting sheet 200 is clamped between the first frame 100 and the second frame 500. In this embodiment, the light-transmitting sheet 200 is clamped between the first frame 100 and the second frame 500. On one hand, the light-transmitting sheet 200 can be securely mounted on the mask. On the other hand, the first frame 100 and the second frame 500 which are detachably connected by means of a buckle can be detached to remove the light-transmitting sheet 200. The filtering assembly 300 is installed in an inner side of the light-transmitting sheet 200, so that the light-transmitting sheet 200 and the filtering assembly 300 can be replaced, and thereby extending the service life of the mask of the present application.

Preferably, the light-transmitting sheet 200 is made with an elastic sheet, which can be deformed easily but is not easily damaged by the first frame 100 and the second frame 500.

In some embodiments, referring to FIG. 1 to FIG. 13, a left side edge and a right side edge of the first frame 100 are attached to a buckle seat 120 respectively. A position of the second frame 500 close to the left side edge and a position close to the right side edge are attached to a buckle 520 respectively. The buckle 520 is located on an inner side of the second frame 500. The buckle 520 and the buckle seat 120 are adapted to connect to each other. In this embodiment, the left and right sides of the first frame 100 and the second frame 500 are adapted to detachably secure to each other.

In other embodiments, the buckle seat 120 is arranged on the upper and lower side edges of the first frame 100, and the buckle 520 is provided on the upper and lower side edges of the second frame 500, so that the first frame 100 and the second frame 500 are detachably secured to each other.

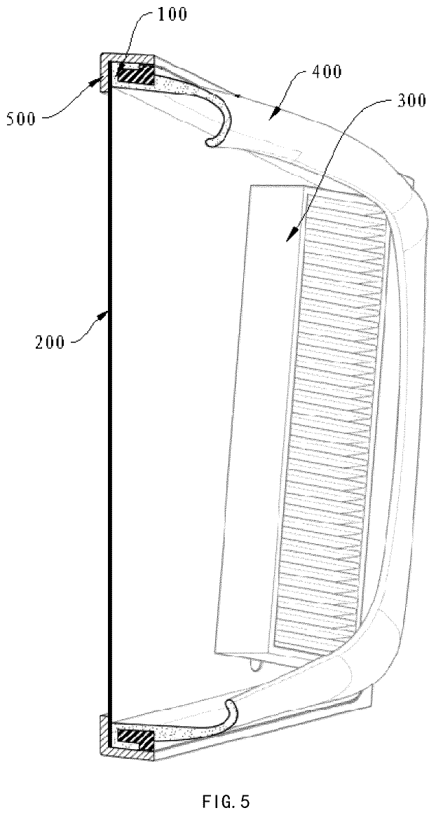

In some embodiments, referring to FIG. 4 and FIG. 5, a peripheral edge of the soft cushion 400 is clamped between a peripheral edge of the first frame 100 and a peripheral edge of the second frame 500. Specifically, a peripheral edge of the soft cushion 400 is first stacked on an outer side of a peripheral edge of the first frame 100, then a peripheral edge of the light-transmitting sheet 200 is stacked on an outer side of a peripheral edge of the soft cushion 400. Then a peripheral edge of the second frame 500 is stacked on an outer side of a peripheral edge of the light-transmitting sheet 200. Finally, the soft cushion 400 and the light-transmitting sheet 200 engage the first frame 100 and the second frame 500 such that the first frame 100, the soft cushion 400, the light-transmitting sheet 200 and the second frame 500 can be sealingly connected together.

In some embodiments, referring to FIG. 4 and FIG. 5, the buckle 520 extends inwards from a peripheral edge of the second frame 500 to the inner side of the buckle base 120. In other words, the light-transmitting piece 200, the soft cushion 400 and the first frame 100 are clamped between the buckle 520 and a peripheral edge of the second frame 500 in that order, thereby ensuring that the first frame 100, the soft cushion 400, the light-transmitting piece 200 and the second frame 500 are sealingly connected together. Since the buckle 520 is elastic, the soft cushion 400, the light-transmitting piece 200 or the filter assembly 300 can be detached for replacement only by pulling the buckle 520 away from the buckle base 120.

In some embodiments, referring to FIG. 4 and FIG. 5, a groove is formed on the outer side wall of the soft cushion 400. The first frame 100 is at least partially clamped in the groove. In one aspect, the soft cushion 400 can be affixed to the first frame 100. In another aspect, this can improve the sealing between the first frame 100 and the soft cushion 400.

In some embodiments, referring to FIG. 1 to FIG. 13, the mask further comprises a suspension assembly 600 for hanging on a user' ears, and head or neck. The suspension assembly 600 is connected to the second frame 500, so that when wearing, the suspension assembly 600 exerts a force on the second frame 500 in the direction towards the first frame 100. In this way, the light-transmitting sheet 200 can be securely clamped between the first frame 100 and the second frame 500. In other embodiments, the suspension assembly 600 may also be connected to the first frame 100.

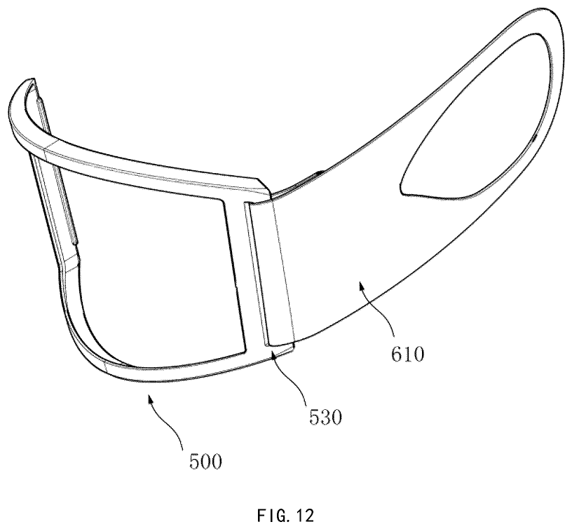

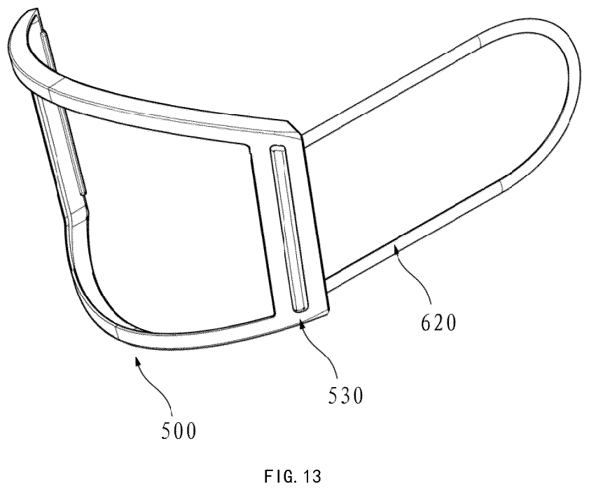

In some embodiments, referring to FIG. 1 to FIG. 13, the second frame 500 comprises an through hole 530 at a position close to the left side edge and a position close to the right side edge. The suspension assembly 600 comprises a belt 610. The belt 610 passes through the through hole 530 for connecting the second frame 500. The suspension assembly 600 may comprise a rope 620. The rope 620 passes through the through hole 530 for connecting the second frame body 500. In this embodiment, the belt 610 or the rope 620 is affixed through the through hole 530. As shown in FIG. 12, when the belt 610 is in use, one end of the belt 610 passes through the through hole 530 and is connected back to the belt 610. The other end of the belt 610 has a lug hole for hanging on an ear of the user. As shown in FIG. 13, when the rope 620 is in use, two ends of the rope 620 pass through the through hole 530 respectively and are affixed to the through hole 530. The rope 620 forms a lug hole for hanging on an ear of the user.

Preferably, when the belt 610 is in use, the through hole 530 has an elongated profile. The belt 610 does not need to be looped as a whole and passes through the through hole 530. Preferably, when the rope body 620 is in use, the mask comprises two through holes 530. The two ends of the rope 620 pass through the through holes 530 respectively and join together at the front side of the second frame body 500, so as to prevent the rope 620 from falling off from the through holes 530.

When the belt 610 is in use, other functional components may also be printed or attached to the belt 610, so as to improve the overall aesthetic and increase functionalities of the mask.

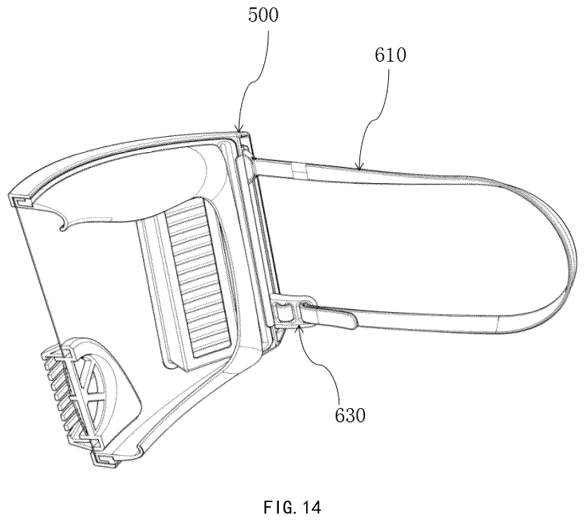

In some embodiments, referring to FIG. 14, the suspension assembly 600 comprises a belt 610 connected to the second frame 500. The belt 610 may have an adjustable length. The belt 610 may have its length adjusted with a hook-and-loop fastener, an adjustable buckle, or the like. As such. the length of the belt 610 can be adjusted according to the circumference of the head of different user making it comfortable for the user to wear. Meanwhile, the belt 610 can be adjusted to fit users with different head circumference. It has a wide range of applications and is convenient to use.

In some embodiments, the second frame 500 comprises openings 530 at a position close to the left edge and a position close to the right edge of the mask. The hanging assembly 600 further comprises an adjusting buckle 630. One end of the belt 610 is adapted to pass through one of the openings 530 for connecting to the second frame 500. The adjusting buckle 630 is attached at the other end of the belt 610. The other end of the belt 610 passes through the through hole 530 and is tied on the adjusting buckle 630. The length of the belt 610 can be adjusted by adjusting the position of the adjusting buckle 630 along the belt 610. If the position of the adjusting buckle 630 along the belt 610 is changed, the reserved length of the belt 610 is also changed, thereby achieving the purpose of adjusting the use length of the belt 610. Alternatively, the adjusting buckle 630 can be affixed on the second frame 500, and the other end of the belt 610 is looped and inserted on the adjusting buckle 630.

In some embodiments, referring to FIG. 1 to FIG. 13, a surface of the light-transmitting sheet 200 has an anti-haze cover layer disposed thereon, so as to extend the service life of the light-transmitting sheet 200. Optionally, the cover layer is also antibacterial. Optionally, the cover layer may be disposed on the surface of the light-transmitting sheet 200 as a film pasting or coating. The cover layer may be directly coated with an anti-haze and antibacterial plastic film.

In some embodiments, referring to FIG. 1 to FIG. 13, the mask comprises a plurality of filter assemblies 300. The bases 310 of the plurality of filter assemblies 300 are adapted to be installed at intervals on the inner side of the light-transmitting sheet 200 to improve the airflow, so as to maintain smooth breathing for the user.

Optionally, the filter assembly 300 may be disposed on a left side and a right side of the light-transmitting sheet 200 or around the periphery of the light-transmitting sheet 200.

In some embodiments, referring to FIG. 1 to FIG. 13, the filter element 320 comprises a filter sponge or a filter sheet having an accordion-folded structure. The filter element 320 may be adjusted according to the airflow required to be filtered. The entire filter material can even be used as a filter element 320.

Preferably, functional components such as an exhaust valve, a water absorption sponge or a sound amplification module may also be installed on the light-transmitting sheet 200.

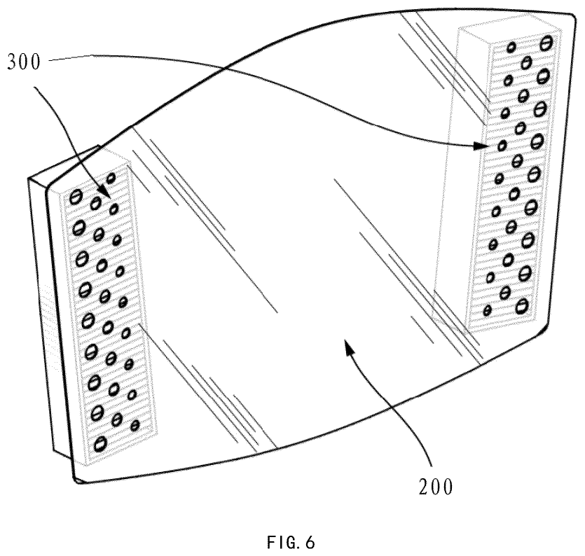

In some embodiments, referring to FIG. 6 to FIG. 8, the base 310 has a rectangular shaped frame. In another embodiment, as shown in FIG. 9 to FIG. 11, the base 310 comprises a plate 311 attached to the inner side of the light-transmitting sheet 200, and a cover 312 for covering the inner side of the plate 311. The ventilation channel is formed with the plate 311 and the cover 312. The rear side of the cover 312 has an opening communicating with the interior of the ventilation channel.

As shown in FIG. 6 to FIG. 8, there are a plurality of air holes 210. The plurality of air holes 210 are distributed in a scattered manner. As shown in FIG. 9 to FIG. 11, the air holes 210 are rectangular and are in communication with the opening of the ventilation channel.

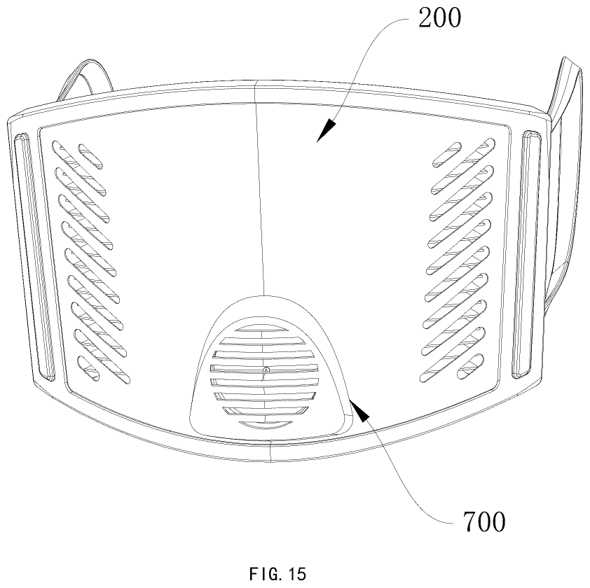

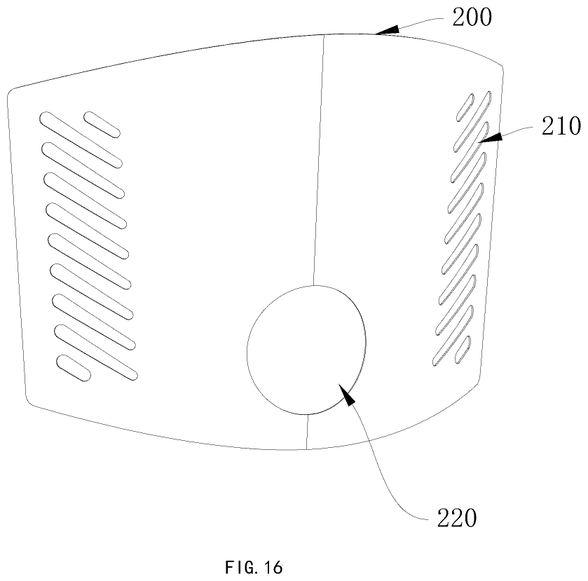

In some embodiments, referring to FIG. 14 and FIG. 15, the light-transmitting sheet 200 comprises an air outlet 220. The air outlet 220 has a one-way valve 700. The one-way valve 700 is adapted to guide the gas inside the light-transmitting sheet 200 to exit to the outer side of the light-transmitting sheet 200 and to prevent the gas outside the light-transmitting sheet 200 from entering to the inner side of the light-transmitting sheet 200. In this way, when the user inhales, air enters the ventilation channel through the air holes 210 on the light-transmitting sheet 200, and enters the enclosing space between the first frame 100, the light-transmitting sheet 200 and the user's face after being filtered by the filter element 320 in the ventilation channel. When the user exhales, the gas exhaled by the user enters the enclosing space. A part of the gas passes through the ventilation channel. After being filtered by the filter element 320 in the ventilation channel, a part of the exhaled gas exits from the air holes 210 on the light-transmitting sheet 200. The other part of the exhaled gas may be directly discharged through the one-way valve 700 without being filtered, so as to improve the exhale efficiency. This design is suitable for a user to perform high-intensity movement in an outdoor environment away from the crowd, so as to accelerate the exhaling and prevent the user from laboured breathing.

In some embodiments, referring to FIG. 14, the one-way valve 700 is adapted to be mounted on the light-transmitting sheet 200 to a position away from the lips of the user. In other words, the air outlet 220 is located on the light-transmitting sheet 200 and away from the position of the lips of the user. This will prevent the one-way valve 700 from blocking the lips. It may be understood that, in other embodiments of this application, the one-way valve 700 may not need to give way to the lip of the user. In this instance, the material of the one-way valve 700 may made from a light-transmitting material. As such, the position of the one-way valve is not a limiting factor.

Optionally, the one-way valve 700 is adapted to be mounted on the light-transmitting sheet 200. The one-way valve 700 is located below the nostrils of the user and away from the position of the lips. As such, the gas exhaled by the user can be discharged through the one-way valve 700 through a short distance, thereby improving the efficiency of gas discharge. It may be understood that, in other embodiments of this application, the one-way valve 700 may also be mounted on the light-transmitting sheet 200 at a position above the nostrils, the left side or the right side of the user. The position of the one-way valve is not a limiting factor here.

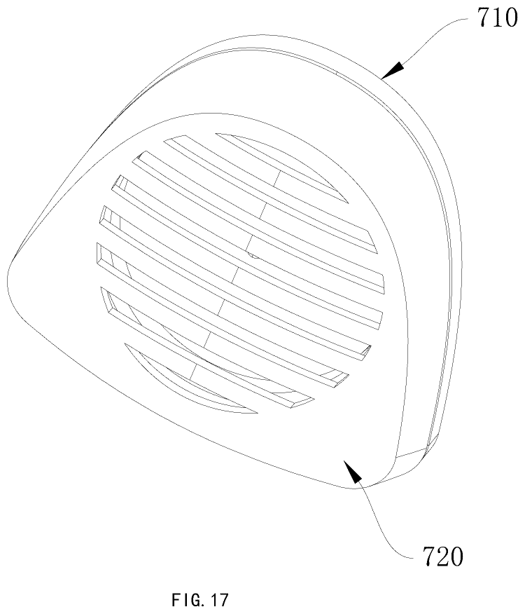

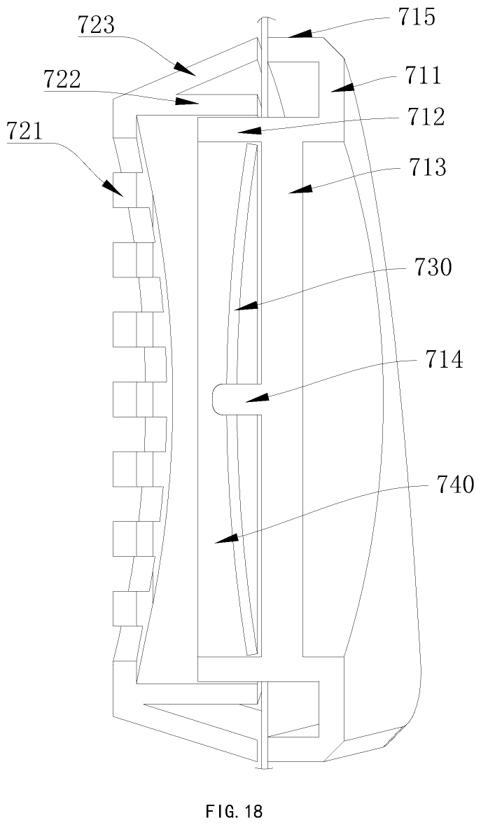

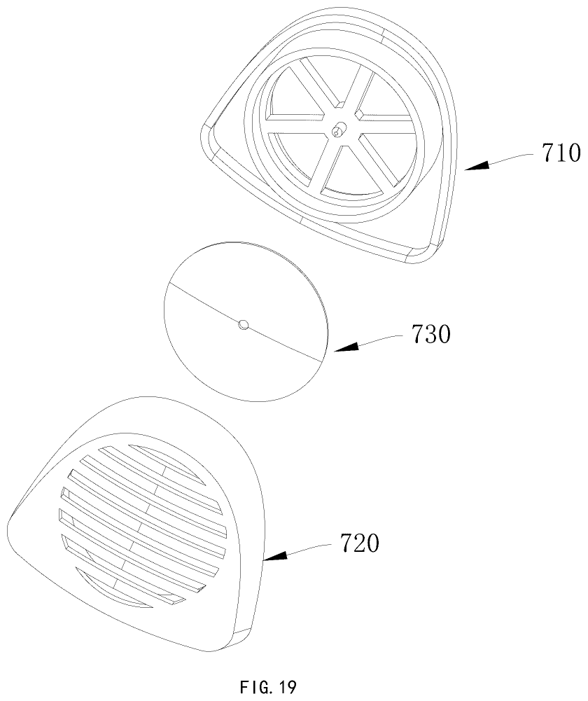

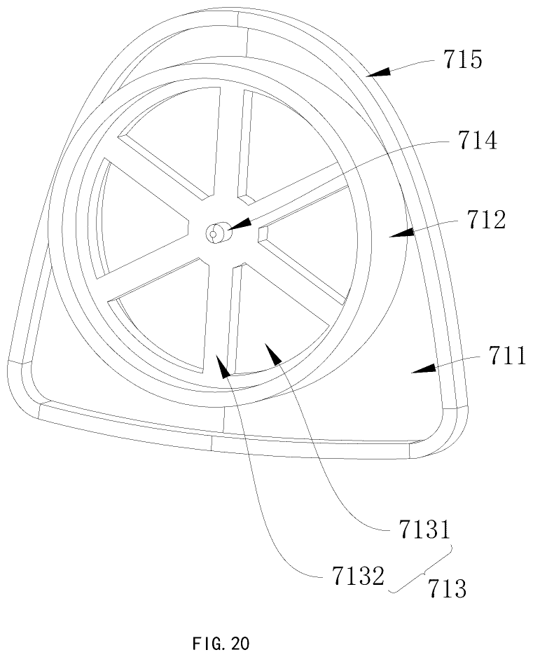

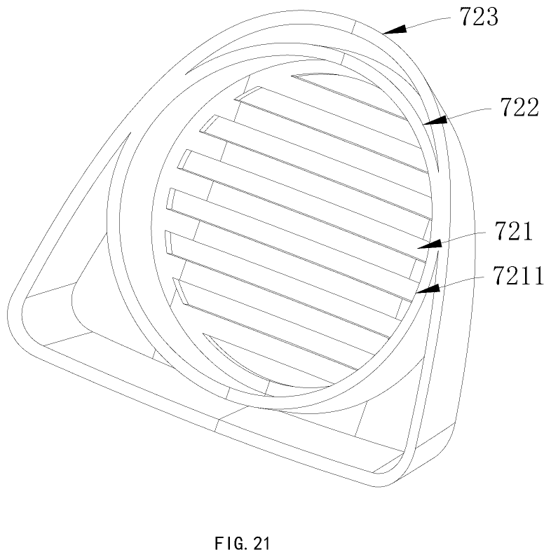

In some embodiments, referring to FIG. 17 to FIG. 20, the one-way valve 700 comprises a valve cavity 740. A mounting column 714 is secured inside the valve cavity 740. The mounting column 714 is sleeved with a diaphragm 730. The diaphragm 730 is concavely arranged to complement the inner side of the light-transmitting sheet 200. A peripheral edge of the diaphragm 730 can be squeezed out of a peripheral inner wall of the valve cavity 740 by the gas inside the diaphragm 730 for connecting an inner side of the light-transmitting sheet with an outside of the light-transmitting sheet 200. A peripheral edge of the diaphragm 730 can be pressed against a peripheral inner wall of the valve cavity 740 by a gas outside the diaphragm 730, thereby preventing gas outside the light-transmitting sheet 200 from entering into the inner side of the light-transmitting sheet 200. In this embodiment, since the diaphragm 730 is concave inwards relative to the inner side of the light-transmitting sheet 200, when the gas exhaled by the user acts on the diaphragm 730, the gas can push a peripheral edge of the diaphragm 730 to bend outwards and deform, so that a peripheral edge of the diaphragm 730 is separated from the inner wall of the valve cavity 740, and the gas can flow to the outer side between the diaphragm 730 and the inner wall of the valve cavity 740. When the user exhales, the gas acts on the outer side of the diaphragm 730 and pushes the diaphragm 730 to continuously bend inwards such that the peripheral edge of the diaphragm 730 can be more tightly attached to a circumferential inner wall of the valve cavity 740, and thereby preventing the gas outside the light-transmitting sheet 200 from flowing to the inner side of the light-transmitting sheet 200.

In some embodiments, referring to FIG. 17 to FIG. 20, the one-way valve 700 includes a base 710 and an outer cover 720. The base 710 and the outer cover 720 are detachably connected to the air outlet 220. The light-transmitting piece 200 is clamped between the base 710 and the outer cover 720. The base 710 and the outer cover 720 form an enclosed valve cavity 740. There are mounting column 714 disposed on the base 710 or the outer cover 720. A first through groove 7131 is formed on the base 710 in communication with the valve cavity 740. A second through groove 7211 is formed on the outer cover 720 in communication with the valve cavity 740. The base 710 and the outer cover 720 are detachably connected at the air outlet 220, so that the one-way valve 700 can be conveniently attached to and removed from the light-transmitting sheet 200. The parts are easy to maintain, clean, or replace, thereby prolonging the service life of the whole mask.

In some embodiments, referring to FIG. 17 to FIG. 20, the base 710 comprises a bottom plate 711 and a first convex ring 712 formed on the bottom plate 711. A peripheral edge of the bottom plate 711 engages an inner side of the light-transmitting sheet 200. The first convex ring 712 passes through the air outlet 220. A mounting plate 713 is formed on an inner wall of the first convex ring 712. The mounting column 714 is formed at the centre of the mounting plate 713. A peripheral edge of the diaphragm 730 engages a circumferential inner wall of the first convex ring 712. The outer cover 720 comprises a cover plate 721 and a second convex ring 722 formed on the cover plate 721. The second convex ring 722 is sleeved outside the first convex ring 712. During installation, the centre of the diaphragm 730 is securely sleeved upon the mounting column 714 first. Then. the first convex ring 712 of the base 710 is inserted into the air outlet 220, so that the bottom plate 711 engages the inner side of the light-transmitting sheet 200 while the first convex ring 712 engages the inner wall of the air outlet 220, Then, the second convex ring 722 of the outer cover 720 is sleeved outside the first convex ring 712. Specifically, the first convex ring 712 interference fits with the second convex ring 722, so that the base 710 and the outer cover 720 are firmly connected while detachable. In addition, the second convex ring 722 is required to engage the outer side of the light-transmitting sheet 200, so as to ensure that the second convex ring 722 is installed properly.

In some embodiments, referring to FIG. 17 to FIG. 20, a peripheral edge of the bottom plate 711 extends outwardly to form a first convex rib 715. A peripheral edge of the cover plate 721 extends outwardly to form a second convex rib 723. The first convex rib 715 and the second convex rib 723 engage an inner side and an outer side of the light-transmitting sheet 200 respectively. The first convex rib 715 and the second convex rib 723 are arranged in corresponding positions inside and outside of the light-transmitting sheet 200. The first convex rib 715 and the second convex rib 723 can be respectively clamped on the inner side and the outer side of the light-transmitting sheet 200 to prevent the base 710 or the outer cover 720 from being separated from the outer side or the inner side of the light-transmitting sheet 200 respectively. Since the light-transmitting sheet 200 has a thin sheet-shaped structure, the structural strength thereof is relatively low. The first convex rib 715 and the second convex rib 723 engage corresponding positions on the inner side and the outer side of the light-transmitting sheet 200, such that the first convex rib 715 and the second convex rib 723 have a shearing effect on the light-transmitting sheet 200 due to a staggered position.

Optionally, the first convex rib 715, the second convex rib 723 and the positions of the second convex ring 722 where the light-transmitting sheet 200 is contacted are designed to complement the radian of the light-transmitting sheet 200. This can improve the connections of the first convex rib 715, the second convex rib 723, the second convex ring 722, and the light-transmitting sheet 200.

Optionally, the mounting plate 713, the first convex ring 712, the second convex ring 722, and the cover plate 721 jointly form a valve cavity 740. The mounting plate 713 is installed opposite to the cover plate 721. The mounting column 714 extends outwardly from the centre of the mounting plate 713 to the direction of the cover plate 721.

Optionally, the mounting plate 713 has a plurality of first through grooves 7131 thereon. Each of the first through grooves 7131 is in communication with the valve cavity 740. Optionally, the mounting plate 713 includes a plurality of connecting strips 7132 distributed in a radial shape. A first through groove 7131 is formed between two adjacent connecting strips 7132. It can be understood that in other embodiments of this application, the first through groove 7131 may also be circular, elliptical, rectangular, or other polygons in shape.

Optionally, a plurality of second through grooves 7211 are formed on the cover plate 721. Each second through groove 7211 is in communication with the valve cavity 740. Optionally, the second through groove 7211 can be rectangular, circular, elliptical, or other polygonal.

Reference throughout this specification to “one embodiment”, “some embodiments”, “an exemplary embodiment”, “an example”, “a specific example”, or “some examples”, means that a particular feature, structure, material, or characteristic described in connection with the embodiment or example is included in at least one embodiment or example of the present application. In this specification, the schematic representation of the above terms does not necessarily refer to the same embodiment or example. Furthermore, the particular features, structures, materials, or characteristics may be combined in any suitable manner in any one or more embodiments or examples.

The above are merely optional embodiments of the present application and are not intended to limit the present application. For those skilled in the art, the present disclosure may have various modifications and changes. Any modifications, equivalent replacements, improvements and the like made within the spirit and principle of the present application shall fall within the scope of the claims of the present application.

1. A mask comprising: a first frame for covering a user's face, wherein the first frame has a first opening opposite to the lips of the user; a light-transmitting sheet engaging an edge of the first opening to cover the first opening, such that light on an inner side of the first frame can be transmitted to an outer side of the first frame through the light-transmitting sheet, wherein the light-transmitting sheet is convex; and a filter assembly for filtering inhaled and exhaled air, wherein the filter assembly comprises a base and a filter element, the base is arranged on the inner side of the light-transmitting sheet and is a has a ventilation channel internally, the light-transmitting sheet comprises air holes in communication with the ventilation channel, and the filter element is installed in the ventilation channel.

2. The mask according to claim 1, further comprising: a soft cushion disposed on the inner side of the first frame and configured to be in contact with a face of a user, wherein the soft cushion is disposed around an edge of the first opening.

3. The mask according to claim 2, further comprising: a second frame, wherein the second frame forms a second opening, and the second frame is adapted to be stacked on an outer side of the first frame, an outer edge of the first frame and an outer edge of the second frame are detachably connected by means of a buckle, the first opening is in communication with the second opening, and the first frame and the second frame are adapted to clamp the light-transmitting sheet is clamped in between thereof.

4. The mask according to claim 3, wherein a left side edge and a right side edge of the first frame each has a buckle seat respectively; a position of the second frame close to the left side edge and a position close to the right side edge has a buckle respectively, the buckles are located on the inner side of the second frame, and the buckle and the buckle seat are adapted to connect to each other.

5. The mask according to claim 4, wherein a peripheral edge of the soft cushion is clamped between a peripheral edge of the first frame and a peripheral edge of the second frame.

6. The mask according to claim 5, wherein the buckle extends inwardly from a peripheral edge of the second frame to an inner side of the buckle base.

7. The mask according to claim 3, further comprising a suspension assembly for hanging on a user' ears, head or neck, wherein the suspension assembly is connected to the second frame.

8. The mask according to claim 7, wherein the second frame comprises an opening at a position close to the left side edge and a position close to the right side edge; the suspension assembly comprises a belt, and the belt passes through the opening for connecting to the second frame; or the suspension assembly comprises a rope, and the rope passes through the opening for connecting to the second frame.

9. The mask according to claim 7, wherein the suspension assembly comprises a belt connected to the second frame, and the length of the belt is adjustable.

10. The mask according to claim 9, wherein the second frame comprises openings at a position close to the left edge and a position close to the right edge; the suspension assembly further comprises an adjusting buckle, and one end of the belt passes through one of the openings for connecting to the second frame; the adjusting buckle is arranged at another end of the belt, such that the another end of the belt passes through another opening and is looped and arranged on the adjusting buckle; or the adjusting buckle is installed on the second frame, and the another end of the belt is looped and arranged on the adjusting buckle.

11. The mask according to claim 1, wherein a surface of the light-transmitting sheet has an anti-haze cover layer.

12. The mask according to claim 1, further comprises a plurality of filtering assemblies, wherein the bases of the plurality of filtering assemblies are arranged at intervals on an inner side of the light-transmitting sheet.

13. The mask according to claim 1, wherein the filter element comprises a filter sponge or a filter sheet having an accordion-folded structure.

14. The mask according to claim 1, wherein the base has a rectangular shaped frame.

15. The mask according to claim 1, wherein the light-transmitting sheet has an air outlet formed thereon, a one-way valve is mounted at the air outlet, and the one-way valve is adapted to guide gas to move from the inner side of the light-transmitting sheet to the outer side of the light-transmitting sheet while preventing the gas outside the light-transmitting sheet from entering into the inner side of the light-transmitting sheet.

16. The mask according to claim 15, wherein the one-way valve is adapted to be mounted on the light-transmitting sheet away from the position of the lips of the user.

17. The mask according to claim 15, wherein the one-way valve comprises a valve cavity, a mounting column is secured in the valve cavity, the mounting column is sleeved with a diaphragm, the diaphragm is concavely arranged to complement the inner side of the light-transmitting sheet; a peripheral edge of the diaphragm engages a peripheral inner wall of the valve cavity, the peripheral edge of the diaphragm is adapted to be squeezed out of a peripheral inner wall of the valve cavity 740 by the gas inside the diaphragm for connecting an inner side of the light-transmitting sheet with the outside the light-transmitting sheet, and the peripheral edge of the diaphragm can be pressed against a peripheral inner wall of the valve cavity by a gas outside the diaphragm.

18. The mask according to claim 17, wherein the one-way valve comprises a base and an outer cover, the base and the outer cover are detachably connected at the air outlet, the light-transmitting sheet is clamped between the base and the outer cover, the base and the outer cover form an enclosed valve cavity, and the mounting column is formed on the base or the outer cover; the base comprises a first through groove in communication with the valve cavity, and the outer cover comprises a second through groove in communication with the valve cavity.

19. The mask according to claim 18, wherein the base comprises a bottom plate, wherein the bottom plate comprises a first convex ring there on, a peripheral edge of the bottom plate engages an inner side of the light-transmitting sheet, the first convex ring passes through an air outlet, an inner wall of the first convex ring has a mounting plate thereon, the mounting plate comprises a mounting column at a centre thereof, and a peripheral edge of the diaphragm engages a circumferential inner wall of the first convex ring; the outer cover comprises a cover plate and a second convex ring formed thereon, and the second convex ring is sleeved outside the first convex ring.

20. The mask according to claim 19, wherein a peripheral edge of the bottom plate extends outwardly to form a first convex rib, a peripheral edge of the cover plate extends outwardly to form a second convex rib, wherein the first convex rib and the second convex rib engages an inner side and an outer side of the light-transmitting sheet respectively, and the first convex rib and the second convex rib are arranged inside and outside at corresponding positions.
